(19) United States
(12) Patent Application Publication
(10) Pub. No.: US 2013/0163177 A1
(43) Pub. Date: Jun. 27, 2013

(54) ELECTRONIC DEVICE WITH HARD DISK DRIVE

(71) Applicant: Li-Ren FU, Shenzhen City (CN)

(72) Inventor: Li-Ren FU, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/338,279

(22) Filed: Dec. 28, 2011

(30) Foreign Application Priority Data
Dec. 23, 2011 (CN) 201110437387.3

(51) Int. Cl. G06F 1/16

(52) U.S. Cl. 361/679.33

(57) ABSTRACT

An electronic device includes a casing, a hard disk drive, and a connecting member. A motherboard is installed in the casing. A first connector is positioned on the motherboard. The hard disk drive includes a second connector. The connecting member includes a third connector engaged with the second connector of the hard disk drive along a first direction, and a fourth connector engaged with the first connector along a second direction perpendicular to the first direction.

### BACKGROUND

1. Technical Field

The present disclosure relates to an electronic device with a hard disk drive.

2. Description of Related Art

An electronic device, such as a computer, generally includes a motherboard and a hard disk drive electrically connected to the motherboard through a cable. However, the cable occupies much space in a casing of the electronic device, which affects the cooling efficiency of the casing.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawing, all the views are schematic, and like reference numerals designate corresponding parts throughout the several views.

FIG. 1 is an exploded, isometric view of an exemplary embodiment of an electronic device, wherein the electronic device includes a connecting member.

FIG. 2 is an inverted, enlarged view of the connecting member of FIG. 1

FIG. 3 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

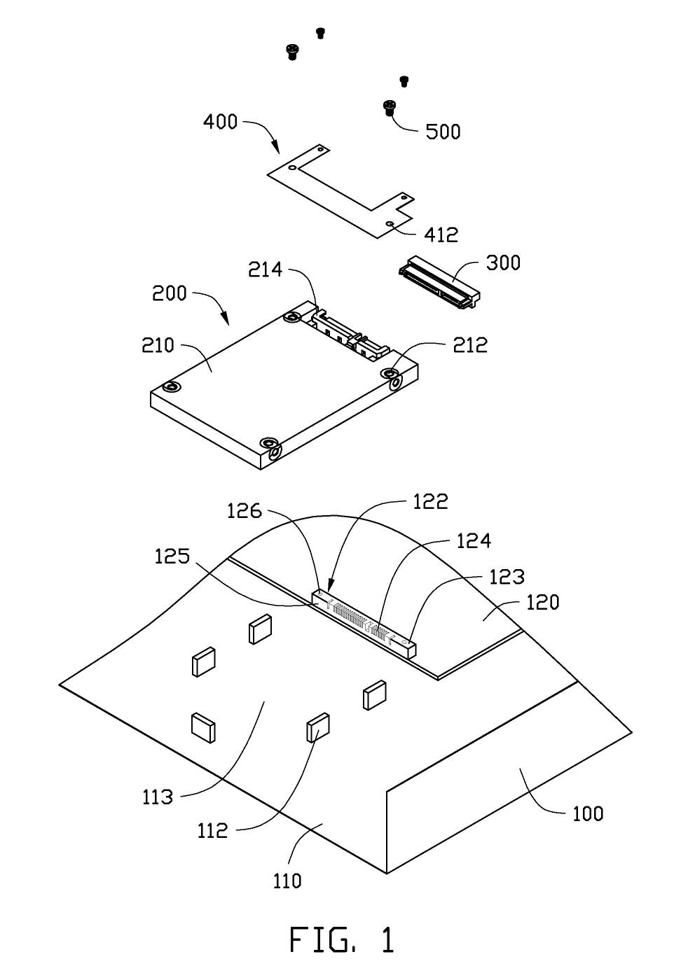

Referring to FIG. 1, an exemplary embodiment of an electronic device includes a casing 100, a hard disk drive 200, a connecting member 300, and a mounting plate 400.

The casing 100 includes an installation wall 110, and a motherboard 120 positioned on the installation wall 110. A plurality of locating pieces 112 protrudes from the installation wall 110 adjacent to the motherboard 120. The locating pieces 112 cooperatively bound a receiving space 113 for receiving the hard disk drive 200. A connector 122 is mounted on the motherboard 120, facing the receiving space 113. The connector 112 includes a top surface 123 parallel to the motherboard 120, and a side surface 125 perpendicularly extending down from a side of the top surface 123 facing the receiving space 113. A plurality of slots 124 is defined in a junction of the top surface 123 and the side surface 125. A plurality of resilient metal engaging pieces (not shown) is installed in each slot 124, and is electrically connected to the motherboard 120. Each of the two opposite ends of the top surface 123 defines a screw hole 126.

The hard disk drive 200 includes a main body 210, and a connector 214 installed on an end of the main body 210. A side surface of the main body 210 defines two screw holes 212 adjacent to the connector 214.

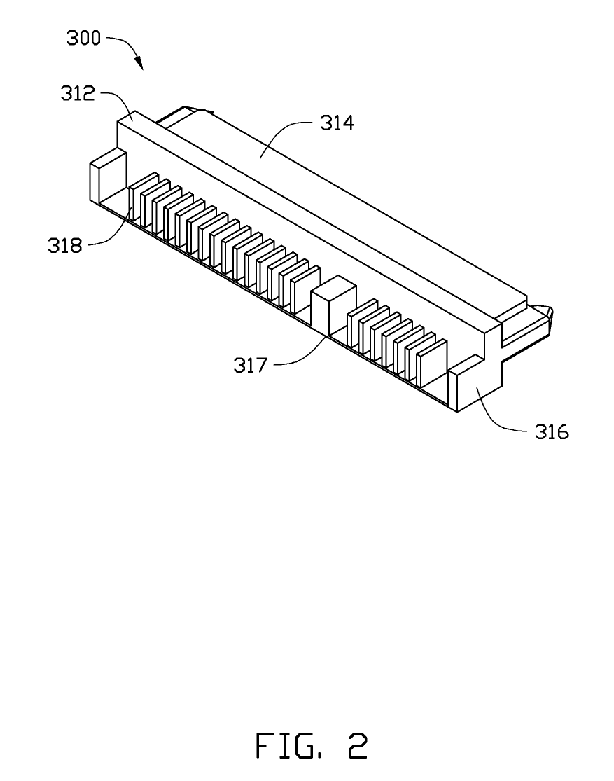

Referring to FIG. 2, the connecting member 300 includes a rectangular connecting portion 312, a connector 314 perpendicularly extending out from a first side of the connecting portion 312, and a connector 316 perpendicularly extending out from a second side of the connecting portion 312 opposite to the connector 314. The connector 316 includes an E-shaped extending portion 317 extending out from the connecting portion 312, and a plurality of conductive terminals 318 extending out from the connecting portion 312. The conductive terminals 318 are electrically connected to the connector 314.

The mounting plate 400 is substantially U-shaped, and defines four through holes 412.

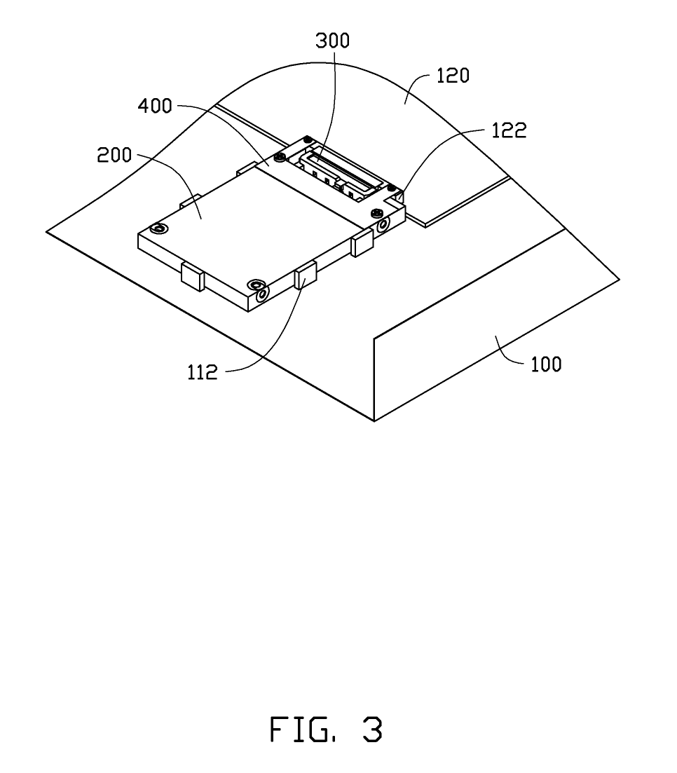

Referring to FIG. 3, in assembly, the connector 214 is engaged with the connector 314 along a first direction parallel to the motherboard 120. The hard disk drive 200 is received in the receiving space 113, with the screw holes 212 away from the installation wall 110. The connector 316 is engaged with the connector 122, each conductive terminal 318 extends through the corresponding slot 124 to electrically connect a corresponding engaging piece in the slot 124 along a second direction perpendicular to the motherboard 120. Therefore, the hard disk drive 200 is electrically connected to the motherboard 120 through the connecting member 300. The mounting plate 400 is attached to the hard disk drive 200. Four screws 500 extend through the through holes 412, to be screwed into the corresponding screws holes 126 and 212.

Even though numerous characteristics and advantages of the embodiments have been set forth in the foregoing description, together with details of the structure and the functions of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. An electronic device, comprising:
a casing comprising a motherboard positioned in the casing and a first connector mounted on the motherboard;
a hard disk drive comprising a second connector mounted to an end; and
a connecting member comprising a third connector engaged with the second connector of hard disk drive along a first direction, and a fourth connector engaged with the first connector along a second direction perpendicular to the first direction.

2. The electronic device of claim 1, wherein the hard disk drive further comprises a main body, the second connector extends from an end of the main body, the first direction of engagement of the second and the third connectors is parallel to the motherboard.

3. The electronic device of claim 1, wherein the second direction of engagement of the fourth connector and the first connector is perpendicular to the motherboard.

4. The electronic device of claim 3, wherein the connecting member further comprises a connecting portion, the third connector extends out from a first side of the connecting portion, the fourth connector extends out from a second side of the connecting portion opposite to the third connector.

5. The electronic device of claim 4, wherein the first connector comprises a top surface parallel to the motherboard, and a side surface adjoining the top surface and facing the hard disk drive, a junction of the top surface and the side surface define a plurality of slots, the fourth connector comprises a plurality of conductive terminals electrically connected to the third connector, to be inserted into the corresponding slots of the first connector, thereby electrically connecting the first connector.

6. The electronic device of claim 5, wherein the casing further comprises an installation wall, a plurality of locating pieces protrude from the installation wall, the locating pieces cooperatively bound a receiving space for receiving the hard disk drive, the motherboard is positioned on the installation wall adjacent to the locating pieces, the slots of the first connector face the receiving space.

7. The electronic device of claim 3, further comprising a mounting plate defining a plurality of through holes, wherein two opposite ends of the first connector define two screw holes, the hard disk drive defines a plurality of screw holes, screws extend through the through holes to screw into the corresponding screw holes of the connector and the hard disk drive.
